(19) United States
(12) Patent Application Publication
(10) Pub. No.: US 2022/0090865 A1
(43) Pub. Date: Mar. 24, 2022

(54) Microchannel Reactions and Separations

(71) Applicants: Nathan Davis, Layton, UT (US); Anthony C. Muscatello, Rockledge, FL (US)

(72) Inventors: Nathan Davis, Layton, UT (US); Anthony C. Muscatello, Rockledge, FL (US)

(21) Appl. No.: 17/482,349

(22) Filed: Sep. 22, 2021

Related U.S. Application Data
(60) Provisional application No. 63/081,841, filed on Sep. 22, 2020.

(51) Int. Cl. F28D 15/02; F28D 15/04

(52) U.S. Cl. CPC F28D 15/0233; F28D 2015/0225; F28D 15/046; F28D 15/0266

(57) ABSTRACT

Methods and devices are disclosed for reacting and separating components. An elongated vessel has a microchannel heat pipe with a hollow space inside the microchannel heat pipe being surrounded by inner walls. A feed stream and a reactant stream are passed into the hollow space, the reactant reacting, resulting in a product stream. A first end of the microchannel heat pipe is heated and an opposite end of the microchannel heat pipe is cooled, producing a gas phase and a liquid phase in reflux. The liquid phase attaches to the inner walls via capillary forces and the vapor phase makes up the balance of the hollow space. The reflux separates components in the product stream, a first portion passing out of a first end of the heat pipe as a liquid stream and a second portion passing out of a second end of the heat pipe as a vapor stream.

### PRIORITY

This application claims benefit to provisional application U.S. 63/081,84, filed Sep. 22, 2020.

### TECHNICAL FIELD

This invention relates generally to chemical synthesis and separations. This invention relates more specifically to microchannel devices and microchannel usage.

### BACKGROUND

Microchannel devices are vessels small enough that capillary forces become the dominant force in the vessel. As such, microchannel devices can be used both terrestrially and in orbit as reactors or for separations.

### SUMMARY

In a first aspect, the disclosure provides a device for reacting and separating components. An elongated vessel has a microchannel heat pipe. A hollow space inside the microchannel heat pipe is surrounded by an inner wall. The heat pipe has a feed inlet, a bottoms outlet at a first end of the microchannel heat pipe adjacent an inner wall of the microchannel heat pipe, an overhead outlet at the second end of the microchannel heat pipe away from the inner wall of the microchannel heat pipe, a heat source wrapped around the first end of the microchannel heat pipe, and a cold source wrapped around the second end of the microchannel heat pipe. A working fluid is fed into the feed inlet and is heated at the first end to evaporate a vapor phase and the vapor phase is cooled at the second end to form a liquid phase, the liquid phase coating the inner wall by capillary force and the vapor phase occupying the balance of the hollow space. A reactor inlet, either adjacent the first end and extending from the inner wall to the vapor phase with a gas-phase reactant injected into the vapor phase and reacting with at least a portion of the working fluid, producing a product, adjacent the second end with a liquid-phase reactant injected into the liquid phase and reacting with at least a portion of the working fluid, producing a product, or both, is provided. The device separates the product and the working fluid into the vapor phase and the liquid phase, removing the vapor phase out the overhead outlet and the liquid phase out the bottoms outlet.

In a second aspect, the disclosure provides a method for reacting and separating components. An elongated vessel has a microchannel heat pipe with a hollow space inside the microchannel heat pipe being surrounded by inner walls. A feed stream and a reactant stream are passed into the hollow space, the reactant reacting, resulting in a product stream. A first end of the microchannel heat pipe is heated and an opposite end of the microchannel heat pipe is cooled, producing a gas phase and a liquid phase in reflux. The liquid phase attaches to the inner walls via capillary forces and the vapor phase makes up the balance of the hollow space. The reflux separates components in the product stream, a first portion passing out of a first end of the heat pipe as a liquid stream and a second portion passing out of a second end of the heat pipe as a vapor stream.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a cross-sectional view of a device and method for reacting and separating components.

FIG. 2 is a process flow diagram showing a method for reacting and separating components.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

Microchannel devices have been used in various aspects of chemical processing. Microchannel reactors and microchannel separators both exist and can be used for each of those purposes, but the present invention provides a way to do both reactions and separations in a single microchannel device, rather than in separate devices. This novel approach allows for a variety of configurations, including but not limited to liquid-liquid reactions combined with liquid-vapor separations, vapor-vapor reactions combined with liquid-vapor separations, and liquid-vapor interface reactions with liquid-vapor separations. These and other configurations can be used for small scale chemical processes in terrestrial applications as well as in orbital and deep space chemical processes ranging from microgravity upwards.

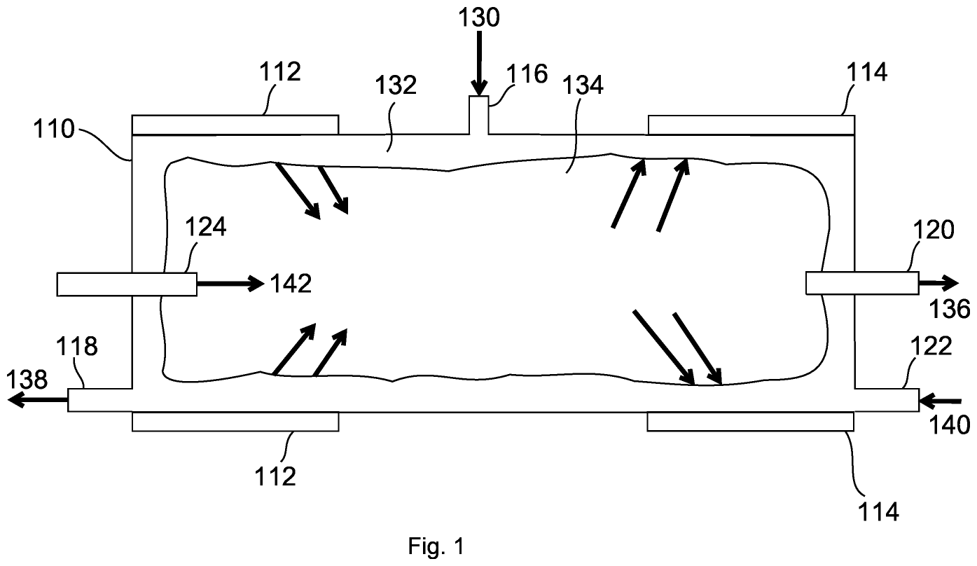

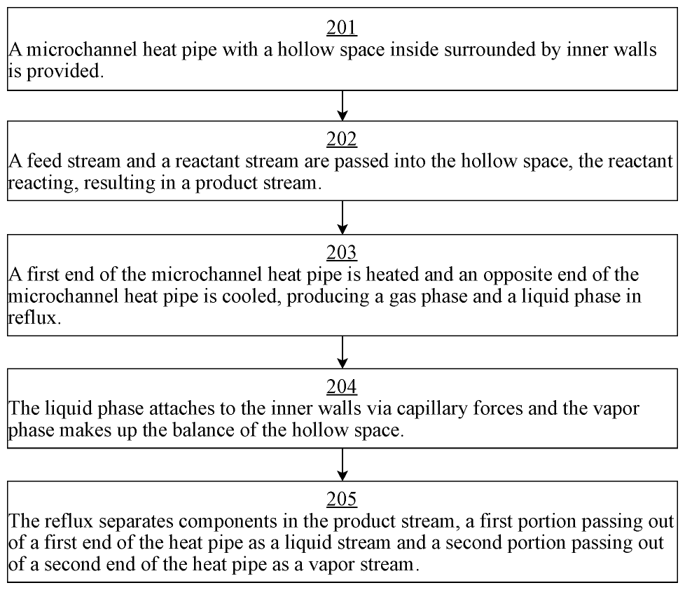

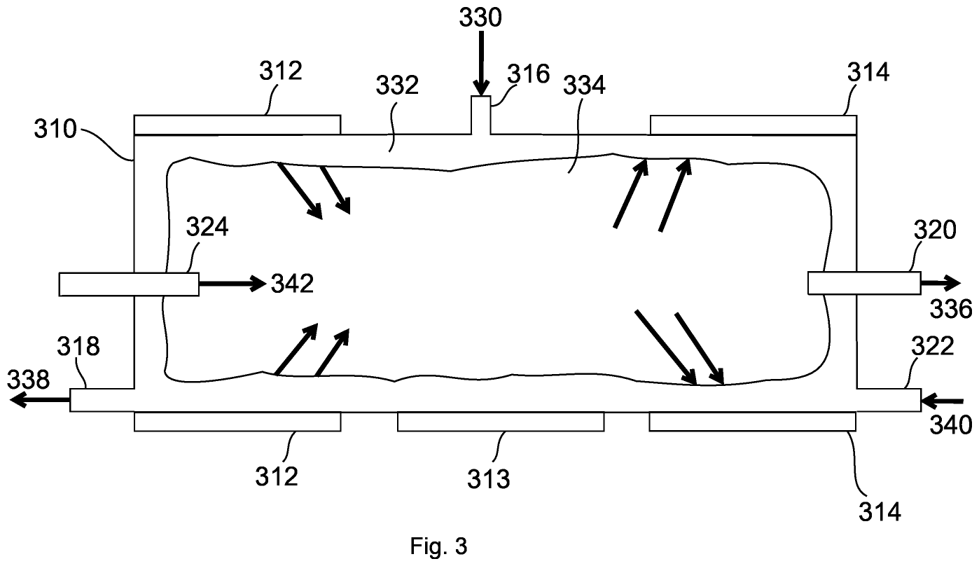

FIG. 1 is a cross-sectional view of a device for reacting and separating components that may be used in one embodiment of the present invention. An elongated vessel consisting of a modified microchannel heat pipe 110 is provided. A first end of the microchannel heat pipe 110 is surrounded by a heater 112 while a second end is surrounded by a cooler 114. The pipe 110 has a feed inlet 116, a liquid outlet 118, a gas outlet 120, a liquid reactant inlet 122, and a gas reactant inlet 124. A working fluid 130 is fed through the feed inlet 116. In some embodiments, the reactant is injected with the working fluid. In other embodiments, the reactant is injected as a liquid reactant 140 through inlet 122 or as a gas reactant 142 through inlet 124. The mixture is heated, producing a vapor phase 134 that travels from the first end to the second end where the vapor is cooled, condensing to a liquid phase 132 and traveling by capillary forces from the second end to the first end. This reflux is a distillation process. Meanwhile, the reactant reacts, producing a product or products. The distillation process then separates the product or products by distillation separation principles into a gas phase 136 and a liquid phase 138.

In one embodiment, an azine and water are injected through the feed inlet 116. The reaction occurs in the vessel 110, producing a ketone and hydrazine hydrate. Through reflux, the ketone is passed out as the gas product and the hydrazine hydrate in water is passed out as the liquid product.

In some embodiments, the elongated vessel consists of a plurality of microchannel heat pipes in series, in parallel, or both. In series, the plurality of heat pipes allows for staged separation with reactions occurring in each stage. In parallel, the plurality of heat pipes allows for scaling up of the amount of reaction product produced and purified in the process. In some embodiments, the plurality of heat pipes are adjacent one another so that heat from one heat pipe heats up the adjacent heat pipe, allowing for more efficient heat exchange.

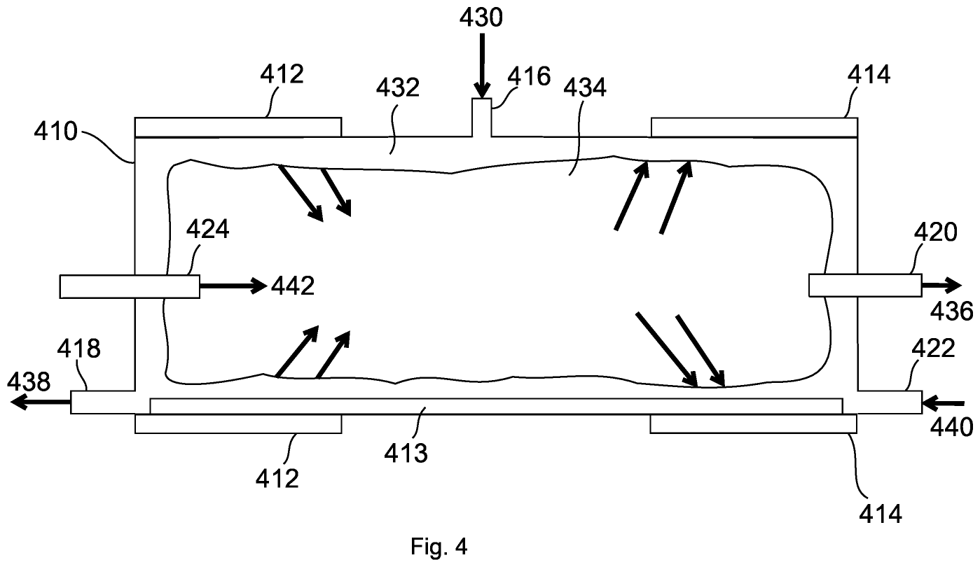

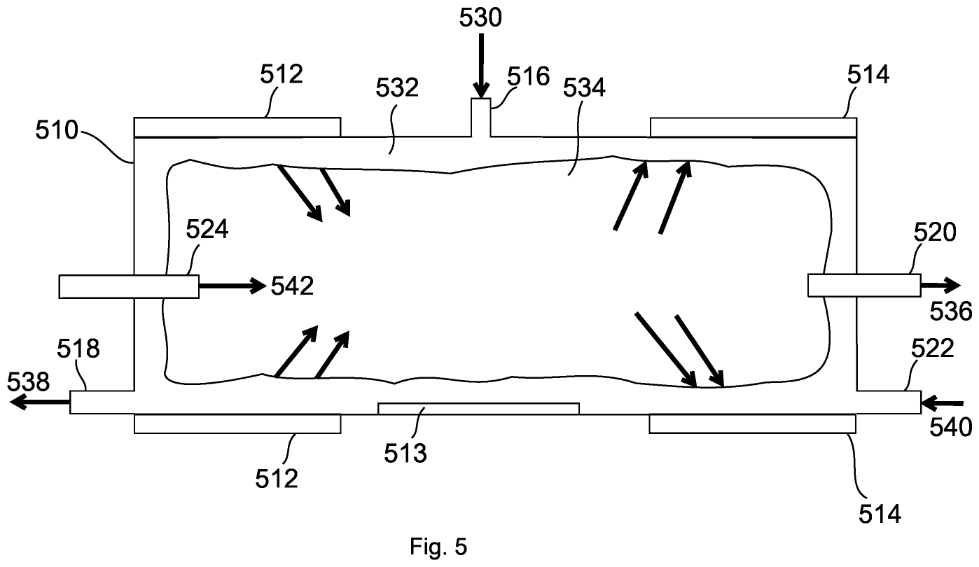

FIG. 2 is a process flow diagram showing a method for reacting and separating components that may be used in one embodiment of the present invention. At 201, a microchannel heat pipe with a hollow space inside surrounded by inner walls is provided. At 202, a feed stream and a reactant stream are passed into the hollow space, the reactant reacting, resulting in a product stream. At 203, a first end of the microchannel heat pipe is heated and an opposite end of the microchannel heat pipe is cooled, producing a gas phase and a liquid phase in reflux. At 204, the liquid phase attaches to the inner walls via capillary forces and the vapor phase makes up the balance of the hollow space. At 205, the reflux separates components in the product stream, a first portion passing out of a first end of the heat pipe as a liquid stream and a second portion passing out of a second end of the heat pipe as a vapor stream.

Microgravity and hypogravity applications are possible for all of the inventions presented in this application. Hypogravity is any gravity less than earth normal but above microgravity. Microchannels conduct liquids at least in part by capillary action and where gravity is reduced or essentially non-existent, this allows for product to still be transported.

In some embodiments, the reactant is a single component that decomposes to form one or more new components in the microchannel heat pipe.

FIG. 3 is a cross-sectional view of a device for reacting and separating components that may be used in one embodiment of the present invention. An elongated vessel consisting of a modified microchannel heat pipe 310 is provided. A first end of the microchannel heat pipe 310 is surrounded by a heater 312 while a second end is surrounded by a cooler 314. The pipe 310 has a feed inlet 316, a liquid outlet 318, a gas outlet 320, a liquid reactant inlet 322, and a gas reactant inlet 324. A working fluid 330 is fed through the feed inlet 316. An electromagnetic emitter 313 is adjacent the heat pipe 310. In some embodiments, the reactant is injected with the working fluid. In other embodiments, the reactant is injected as a liquid reactant 340 through inlet 322 or as a gas reactant 342 through inlet 324. The mixture is heated, producing a vapor phase 334 that travels from the first end to the second end where the vapor is cooled, condensing to a liquid phase 332 and traveling by capillary forces from the second end to the first end. This reflux is a distillation process. The electromagnetic emitter 313 emits photons into the liquid phase 332 that cause the reaction to occur. The distillation process then separates the product or products by distillation separation principles into a gas phase 336 and a liquid phase 338. In some embodiments, the electromagnetic emitter 313 is replaced with a magnetoelectric emitter. Photons can include any electromagnetic radiation. In a preferred embodiment, ionizing radiation such as UV is produced. Other ionizing radiation, such as microwaves, X-rays, and gamma rays may be used.

FIG. 4 is a cross-sectional view of a device for reacting and separating components that may be used in one embodiment of the present invention. An elongated vessel consisting of a modified microchannel heat pipe 410 is provided. A first end of the microchannel heat pipe 410 is surrounded by a heater 412 while a second end is surrounded by a cooler 414. The pipe 410 has a feed inlet 416, a liquid outlet 418, a gas outlet 420, a liquid reactant inlet 422, and a gas reactant inlet 424. A working fluid 430 is fed through the feed inlet 416. A catalyst 413 is situated inside the heat pipe 410. In some embodiments, the reactant is injected with the working fluid. In other embodiments, the reactant is injected as a liquid reactant 440 through inlet 422 or as a gas reactant 442 through inlet 424. The mixture is heated, producing a vapor phase 434 that travels from the first end to the second end where the vapor is cooled, condensing to a liquid phase 432 and traveling by capillary forces from the second end to the first end. This reflux is a distillation process. The catalyst 413 causes the reaction to occur in the liquid phase 432. The distillation process then separates the product or products by distillation separation principles into a gas phase 436 and a liquid phase 438.

FIG. 5 is a cross-sectional view of a device for reacting and separating components that may be used in one embodiment of the present invention. An elongated vessel consisting of a modified microchannel heat pipe 510 is provided. A first end of the microchannel heat pipe 510 is surrounded by a heater 512 while a second end is surrounded by a cooler 514. The pipe 510 has a feed inlet 516, a liquid outlet 518, a gas outlet 520, a liquid reactant inlet 522, and a gas reactant inlet 524. A working fluid 530 is fed through the feed inlet 516. An electricity source 513 is situated inside the heat pipe 510. In some embodiments, the reactant is injected with the working fluid. In other embodiments, the reactant is injected as a liquid reactant 540 through inlet 522 or as a gas reactant 542 through inlet 524. The mixture is heated, producing a vapor phase 534 that travels from the first end to the second end where the vapor is cooled, condensing to a liquid phase 532 and traveling by capillary forces from the second end to the first end. This reflux is a distillation process. The electricity source 513 puts electrons into the liquid phase 532, causing the reaction to occur. The distillation process then separates the product or products by distillation separation principles into a gas phase 536 and a liquid phase 538.

The invention has been described with reference to various specific and preferred embodiments and techniques. Nevertheless, it is understood that many variations and modifications may be made while remaining within the spirit and scope of the invention.

What is claimed is:

1. A device for reacting and separating components, comprising:
an elongated vessel comprising a microchannel heat pipe, a hollow space inside the microchannel heat pipe being surrounded by an inner wall;
a feed inlet;
a bottoms outlet at a first end of the microchannel heat pipe adjacent an inner wall of the microchannel heat pipe;
an overhead outlet at the second end of the microchannel heat pipe away from the inner wall of the microchannel heat pipe;
a heat source wrapped around the first end of the microchannel heat pipe;
a cold source wrapped around the second end of the microchannel heat pipe;
wherein a working fluid is fed into the feed inlet and is heated at the first end to evaporate a vapor phase and the vapor phase is cooled at the second end to form a liquid phase, the liquid phase coating the inner wall by capillary force and the vapor phase occupying the balance of the hollow space;
a reactor inlet selected from the list comprising:
a reactor inlet adjacent the first end and extending from the inner wall to the vapor phase, wherein a gas-phase reactant is injected into the vapor phase and reacts with at least a portion of the working fluid, producing a product;
a reactor inlet adjacent the second end, wherein a liquid-phase reactant is injected into the liquid phase and reacts with at least a portion of the working fluid, producing a product; and
a combination thereof;
the device separating the product and the working fluid into the vapor phase and the liquid phase, removing the vapor phase out the overhead outlet and the liquid phase out the bottoms outlet.

2. The device of claim 1, wherein the elongated vessel comprises a plurality of microchannel heat pipes in series.

3. The device of claim 1, wherein the elongated vessel comprises a plurality of microchannel heat pipes in parallel.

4. A method for reacting and separating components, comprising:
providing an elongated vessel comprising a microchannel heat pipe, a hollow space inside the microchannel heat pipe being surrounded by inner walls;
passing a feed stream and a reactant into the hollow space, the reactant reacting, resulting in a product stream;
heating a first end of the microchannel heat pipe and cooling an opposite end of the microchannel heat pipe, producing a gas phase and a liquid phase in reflux, wherein the liquid phase attaches to the inner walls via capillary forces and the vapor phase comprises the balance of the hollow space; and
wherein the reflux separates components in the product stream, a first portion passing out of a first end of the heat pipe as a liquid stream and a second portion passing out of a second end of the heat pipe as a vapor stream.

5. The method of claim 4, wherein the elongated vessel comprises a plurality of microchannel heat pipes in series.

6. The method of claim 4, wherein the elongated vessel comprises a plurality of microchannel heat pipes in parallel.

7. The method of claim 4, wherein the reactant reacts with a portion of the feed stream during reflux.

8. The method of claim 4, wherein the method is conducted in hypogravity or microgravity.

9. The method of claim 4, wherein the reactant is a single component and reacts in a decomposition reaction to form one or more new components.

10. The method of claim 4, wherein the feed stream comprises water and the reactant is an azine which reacts in reflux to form a ketone and hydrazine hydrate, the ketone leaving as the vapor stream and the hydrazine hydrate leaving with the liquid stream.
